(19) United States
(12) Patent Application Publication
(10) Pub. No.: US 2015/0371151 A1
(43) Pub. Date: Dec. 24, 2015

(54) ENERGY INFRASTRUCTURE SENSOR DATA RECTIFICATION USING REGRESSION MODELS

(71) Applicant: THE REGENTS OF THE UNIVERSITY OF CALIFORNIA, Oakland, CA (US)

(72) Inventors: Michael V. Georgescu, Van Nuys, CA (US); Igor Mezic, Goleta, CA (US)

(73) Assignee: THE REGENTS OF THE UNIVERSITY OF CALIFORNIA, Oakland, CA (US)

(21) Appl. No.: 14/745,140

(22) Filed: Jun. 19, 2015

Related U.S. Application Data
(60) Provisional application No. 62/015,233, filed on Jun. 20, 2014.

(51) Int. Cl. G06N 99/00; G05B 19/048

(52) U.S. Cl. CPC G06N 99/005; G05B 19/048; G05B 2219/2639

(57) ABSTRACT

A system and method are provided for physical data rectification using regression models. For example, the physical data may be energy infrastructure sensor data. The system may perform an estimation of sensor data during periods of data dropout using a regression model. The system may assess the accuracy of regression models through the comparison of probability distribution functions of physical data estimated using the regression model and actual physical data.

### CROSS-REFERENCE TO RELATED APPLICATIONS

This application claims priority under 35 U.S.C. §119(e) to U.S. Provisional Patent Application No. 62/015,233, entitled “ENERGY INFRASTRUCTURE SENSOR DATA RECTIFICATION USING REGRESSION FUNCTION METHODS” and filed on Jun. 20, 2014, the entire disclosure of which is hereby incorporated by reference.

### STATEMENT REGARDING FEDERALLY SPONSORED RESEARCH AND DEVELOPMENT

This invention was made with Government support under Contract No. W911NF-11-1-0511 awarded by the U.S. Army. The Government has certain rights in this invention.

### TECHNICAL FIELD

This invention relates to energy infrastructure sensor data rectification using regression models.

### BACKGROUND

As more devices, buildings, and energy sources are added to the energy grid, the need for monitoring and prediction of the stability of energy infrastructure systems becomes an increasingly critical need. Widespread blackouts in large-scale interconnected power systems are repeatedly emerging throughout the world. Examples include the 1965 Northeast America blackout, the 1996 Western North America blackouts, and the 2003 blackouts in North America and Europe, as well as a massive blackout in India in August 2012 in which the grid approached collapse and left 700 million people without electrical power for several days.

### SUMMARY

The present disclosure describes a system and method for the estimation of physical data (e.g., energy infrastructure sensor data) during periods of data dropout using machine learning methods. As an example, building energy consumption may be monitored using meters that tabulate energy consumption over time. The occurrence of faults, such as equipment malfunction or loss of building power, may prevent some energy consumption data from being measured and recorded. Such events can occur frequently and create large “gaps” in measured data. Using regression models, a system can forecast building energy usage. Regression models include, but are not limited to, linear regressions, polynomial regressions, logistic regressions, multivariate linear regressions, neural networks, kernel regressions, such as support vector regressions (SVR), and/or the like. When applied to time periods where data is unavailable, this technique allows a system to rectify energy infrastructure sensor data during periods of data dropout.

One aspect of the disclosure provides a system for physical data rectification. The system comprises a computer data repository configured to store a data set, the data set comprising actual physical data measured by a physical sensor. The system further comprises a computing system comprising one or more computing devices, the computing system in communication with the computer data repository and programmed to implement: a historical data estimator configured to: retrieve the actual physical data from the computer data repository, wherein the actual physical data corresponds to a first time interval; determine a parameter that is correlated with the actual physical data; retrieve first measurements associated with the determined parameter and that correspond to the first time interval; generate a mapping of the retrieved first measurements to the retrieved actual physical data using machine learning; retrieve second measurements associated with the determined parameter and that correspond to a second time interval that is different than the first time interval; and estimate physical data for the second time interval using the retrieved second measurements and the generated mapping.

The system of the preceding paragraph can have any sub-combination of the following features: where the historical data estimator is further configured to: estimate second physical data for the first time interval using the retrieved first measurements and the generated mapping, compare the estimated second physical data and the retrieved actual physical data, and determine a performance benchmark associated with the physical sensor based on the comparison; where the historical data estimator is further configured to: estimate second physical data for the first time interval using the retrieved first measurements and the generated mapping, compare the estimated second physical data and the retrieved actual physical data, determine a difference between the estimated second physical data and the retrieved actual physical data based on the comparison, and determine that a fault has occurred in response to a determination that the difference is greater than a threshold value; where the historical data estimator is further configured to transmit an indication to a user device that the fault has occurred; where the physical sensor is located in one of a building, an industrial process, a vehicle, a power grid, a renewable energy source, or a conventional energy source; where the computer system is further programmed to implement a data forecaster configured to: generate a control sequence based on the estimated physical data, and transmit the control sequence to a control system such that the control system can adjust operation of the physical sensor; where the control system is a supervisory control and data acquisition system; where the parameter is at least one of hour of a day, day of a week, temperature, solar radiation, or relative humidity; where the actual physical data comprises at least one of voltage, current, temperature, humidity, air flow, electric power usage, water usage, gas usage, occupancy, light, smoke, or network packets; where the physical sensor comprises at least one of a thermostat, a humidistat, or a utility meter; where the historical data estimator is further configured to generate the mapping using a regression model; and where the regression model comprises a support vector regression.

Another aspect of the disclosure provides a method for rectifying physical data. The method comprises: as implemented by a computer system comprising one or more computing devices, the computer system configured with specific executable instructions, retrieving actual physical data measured by a physical sensor from a control system, wherein the actual physical data corresponds to a first time interval; determining a parameter that is correlated with the actual physical data; retrieving first measurements associated with the determined parameter and that correspond to the first time interval; generating a mapping of the retrieved first measurements to the retrieved actual physical data using machine learning; retrieving second measurements associated with the determined parameter and that correspond to a second time interval that is different than the first time interval; and estimating physical data for the second time interval using the retrieved second measurements and the generated mapping.

The method of the preceding paragraph can have any sub-combination of the following features: where the method further comprises estimating second physical data for the first time interval using the retrieved first measurements and the generated mapping, comparing the estimated second physical data and the retrieved actual physical data, and determining a performance benchmark associated with the physical sensor based on the comparison; where the method further comprises estimating second physical data for the first time interval using the retrieved first measurements and the generated mapping, comparing the estimated second physical data and the retrieved actual physical data, determining a difference between the estimated second physical data and the retrieved actual physical data based on the comparison, and determining that a fault has occurred in response to a determination that the difference is greater than a threshold value; where the method further comprises transmitting an indication to a user device that the fault has occurred; where the physical sensor is located in one of a building, an industrial process, a vehicle, a power grid, a renewable energy source, or a conventional energy source; where the method further comprises generating a control sequence based on the estimated physical data, and transmitting the control sequence to a control system such that the control system can adjust operation of the physical sensor; and where generating a mapping comprises generating the mapping of the retrieved first measurements to the retrieved actual physical data using a regression model.

Another aspect of the disclosure provides a non-transitory computer-readable medium having stored thereon a historical data estimator for using machine-learning techniques to rectify physical data, the historical data estimator comprising executable code that, when executed on a computing device, implements a process comprising: retrieving actual physical data measured by a physical sensor from a control system, wherein the actual physical data corresponds to a first time interval; determining a parameter that is correlated with the actual physical data; retrieving first measurements associated with the determined parameter and that correspond to the first time interval; generating a mapping of the retrieved first measurements to the retrieved actual physical data using machine learning; retrieving second measurements associated with the determined parameter and that correspond to a second time interval that is different than the first time interval; and estimating physical data for the second time interval using the retrieved second measurements and the generated mapping.

### BRIEF DESCRIPTION OF THE DRAWINGS

Referring now to the drawings in which like reference numbers represent corresponding parts throughout:

FIG. 1 illustrates a block diagram showing the various components in an energy data rectification system.

FIG. 2 is a Wasserstein distance comparison of physical data estimated using a support vector regression (SVR) model and actual physical data for three different meter types.

FIG. 3 illustrates a user interface depicting the yearlong combined actual and estimated consumption of a building meter that exhibited a five month data dropout.

FIG. 4A illustrates a user interface depicting the measurements collected by a building meter in a 350,000 square foot office building over a month period in which two weeks of data is missing due to a sensor malfunction.

FIG. 4B illustrates a user interface depicting the measurements collected by a building meter in a 350,000 square foot office building and building meter data estimated using a regression model in which the building meter data is estimated based on the hour of the day and the day of the week.

FIG. 4C illustrates a user interface depicting the measurements collected by a building meter in a 350,000 square foot office building and building meter data estimated using a regression model in which the building meter data is estimated based on the hour of the day, the day of the week, and outdoor air temperature.

FIG. 5 illustrates a process that may be used by the energy data rectification server of FIG. 1 to rectify missing physical data.

### DETAILED DESCRIPTION OF SPECIFIC EMBODIMENTS

### Introduction

Natural phenomena can be used as a source of energy for a device or a group of devices or can act as a disturbance. In both cases, knowledge of past or future states linked to natural phenomena may be useful for planning and operation. For example, direct solar, wind, wave, tidal, geothermal, biomass (e.g., green crude oil) cycling, and/or the like are the main inputs for renewable energy production systems. However, the wider penetration of renewable energy sources has become a potential cause of power system instability. Renewable sources include solar and wind power generations, and their outputs normally fluctuate due to the uncertainty in weather. In the modern power system, with a large number of distributed sources, the fluctuating power sources may require more monitoring. Standard supervisory control and data acquisition (SCADA) systems continuously collect information of a power system's state and distribute such information to power system operators.

Recent advances in real-time phasor measurement units (PMUs) may offer an advanced data collection method using phases of AC voltages, which is described in greater detail in A. G. Phadke, “Synchronized phasor measurement in power systems,” IEEE Comput. Appl. Power, vol. 6, no. 2, pp. 10-15, April 1993, J. De La Ree, V. Centeno, J. S. Thorp, and A. G. Phadke, “Synchronized phasor measurement applications in power systems,” IEEE Trans. Smart Grid, vol. 1, no. 1, pp. 20-27, June 2010, and A. Armenia and J. H. Chow, “A flexible phasor data concentrator design leveraging existing software technologies,” IEEE Trans. Smart Grid, vol. 1, no. 1, pp. 73-81, June 2010, which are hereby incorporated herein by reference in their entireties. Analytical methods along these lines are further described in D. R. Ostojić, “Spectral monitoring of power system dynamic performances,” IEEE Trans. Power Syst., vol. 8, no. 2, pp. 445-451, May 1993, A. R. Messina and V. Vittal, “Nonlinear, non-stationary analysis of interarea oscillations via Hilbert spectral analysis,” IEEE Trans. Power Syst., vol. 21, no. 3, pp. 1234-1241, August 2006, and A. R. Messina and V. Vittal, “Extraction of dynamic patterns from wide-area measurements using empirical orthogonal functions,” Power Systems, IEEE Transactions, vol. 22, no. 2 , pp. 682-692, May 2007, which are hereby incorporated herein by reference in their entireties.

In the United States, buildings consume 40% of the nation's generated energy. In line with the country's goal of achieving a reduction in energy usage and enhancing energy security, an industry has developed around improving building energy efficiency. With an increase in the prioritization of building energy efficiency, the monitoring, management, and verification of building energy use is a task of growing scope. Tasks in this field include energy use billing, building performance classification, identification of retrofit opportunities, and/or the like. Often, building utility meters are the first (and sometime only) measurements which are used for completing these tasks.

However, with incomplete data, errors can arise. Despite the wide-ranging social, economic, and political impacts, the monitoring and prediction of energy infrastructure systems has been hampered by extended dropouts of critically important sensor information. Devices, or groups of devices, which exchange information between each other, are susceptible to data dropout during data transmission, which may prevent the effective understanding and accurate forecasting of energy usage. Thus, it may be advantageous to determine methods for rectifying missing data to prevent or reduce the likelihood that errors arise.

Numerous recent studies exist on regression-type analysis of building energy for the prediction of data. For example, parametric linear regression models have previously been used towards heating energy prediction, such as described in Catalina, Tiberiu, Vlad Iordache, and Bogdan Caracaleanu. 2013. “Multiple regression model for fast prediction of the heating energy demand.” Energy and Buildings 57 (0): 302-312, Soldo, Boidar, Primo Potonik, Goran imunovi, Tomislavari, and Edvard Govekar. 2014. “Improving the residential natural gas consumption forecasting models by using solar radiation.” Energy and Buildings 69 (0): 498-506, Ghiaus, Cristian. 2006. “Experimental estimation of building energy performance by robust regression.” Energy and Buildings 38 (6): 582-587, and Martani, Claudio, David Lee, Prudence Robinson, Rex Britter, and Carlo Ratti. 2012. “ENERNET: Studying the dynamic relationship between building occupancy and energy consumption.” Energy and Buildings 47 (0): 584-591, which are hereby incorporated herein by reference in their entireties. In such linear regression models, utility usage may be correlated to factors that are believed to influence their consumption, such as weather variability, time of day, occupancy, and/or the like. As another example, machine learning techniques have previously been applied in the form of artificial neural networks (ANN), such as described in Neto, Alberto Hernandez, and Flvio Augusto Sanzovo Fiorelli. 2008. “Comparison between detailed model simulation and artificial neural network for forecasting building energy consumption.” Energy and Buildings 40 (12): 2169-2176, which is hereby incorporated herein by reference in its entirety, and support vector machines, such as described in Dong, Bing, Cheng Cao, and Siew Eang Lee. 2005. “Applying support vector machines to predict building energy consumption in tropical region.” Energy and Buildings 37 (5): 545-553, which is hereby incorporated herein by reference in its entirety. Generally, the methods described in these works create predictions of energy consumption only after a long period of time has passed (e.g., greater than 1 hour).

Accordingly, systems and methods are disclosed herein for resolving missing energy data during periods of data dropout to, for example, complete tasks relating to grid monitoring, grid management, grid instability prevention, building energy monitoring, building energy management, building energy verification, and/or the like. As compared to the systems and methods disclosed in the art referenced above, the systems and methods described herein may be capable of accurately predicting, at any relevant time scale (e.g., yearly, half yearly, seasonally, monthly, weekly, daily, hourly, sub-hourly, etc.), missing energy data. The systems and methods described herein may use machine learning methods (e.g., regression models) to estimate the missing information. Accuracy of the regression models may be assessed via the comparison of probability distribution functions between model estimates and actual data. Applications of the systems and methods described herein may include, but are not limited to, building energy usage, demand response, integration and balancing of renewable energy resources in the energy grid, power grid dynamics and stability, and/or network-based applications.

As an example, building energy consumption may be monitored using sensors, such as meters, that tabulate energy consumption over time. The occurrence of faults, such as an equipment malfunction or the loss of building power, may prevent energy consumption data from being measured and recorded. Such events can occur frequently and create large “gaps” in measured data. Using regression models, a system can create a forecast of building energy usage. Regression models include, but are not limited to, linear regressions, polynomial regression, logistic regressions, multivariate linear regressions, neural networks, kernel regressions, such as support vector regressions (SVR), and/or the like. When applied to time periods where data is unavailable, this technique may allow a system to effectively rectify energy consumption data during periods of data dropout.

In the following description of the preferred embodiments, reference is made to the accompanying drawings which form a part hereof, and in which is shown by way of illustration, a specific embodiment in which the present disclosure may be practiced. It is to be understood that other embodiments may be utilized and structural changes may be made without departing from the scope of the present disclosure.

### System Overview

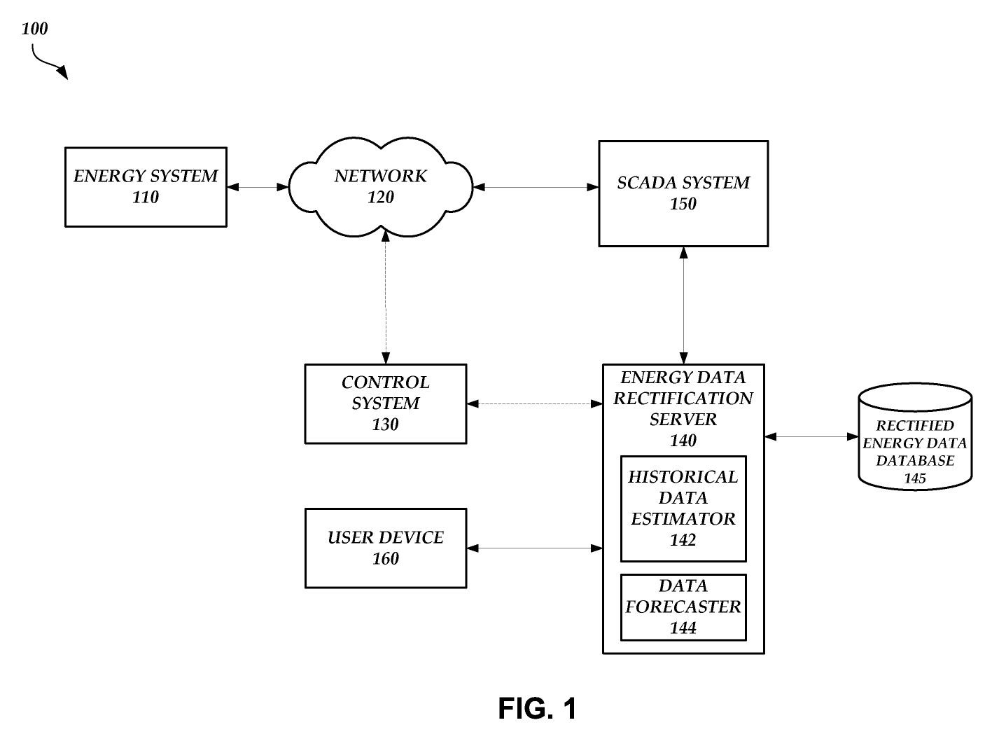

FIG. 1 illustrates a block diagram showing the various components in an energy data rectification system 100. As illustrated in FIG. 1, the energy data rectification system 100 comprises an energy system 110, a control system 130, an energy data rectification server 140, a rectified energy data database 145, a SCADA system 150, and a user device 160.

The energy system 110 may be one of a variety of structures or components, such as one or more buildings, one or more industrial processes (e.g., a factory), one or more vehicles, a power grid, a renewable energy source (e.g., hydroelectric, solar, wind, etc.), a conventional energy source (e.g., generators, natural gas power plants, nuclear power plants, coal power plants, etc.), and/or the like. The energy system 110 may include various sensors (e.g., thermostats, humidistats, utility meters, etc.) that measure physical data. The physical data may comprise an environmental aspect, such as temperature or humidity, but may also comprise a system aspect, such as power consumption or electrical flow. The readings from the sensors may also be converted to an appropriate form to facilitate analysis. For example, a sensor may record a change in temperature or a change in humidity, or may instead record an integral of these values over a period of time. Alternatively, a computer system can perform this post-processing on the raw sensor data. Physical data may, for example, include voltage, current, temperature, humidity, air flow, electric power usage, water usage, gas usage, occupancy, light, smoke, network packets, and/or the like. Each sensor in the energy system 110 may store information locally. Alternatively or in addition, one or more sensors may transmit the measured information to a central system within the energy system 110. Those sensors that communicate their information may be wireless or wired. Certain embodiments contemplate the sensors comprising an ad hoc infrastructure facilitating the transmission of readings to a central system. In certain embodiments comprising wireless sensors, routers within the energy system 110 may be used to collect data from local sensors and pass them on to the central system.

The SCADA system 150 may include a control system that operates over communication channels to provide a user or operator with control over remote equipment. The SCADA system 150 may also include a data acquisition system that acquires and stores status information of the remote equipment. For example, the SCADA system 150 may allow for the control of structures or components within the energy system 110 and may acquire and store the physical data measured by sensors of the energy system 110.

The SCADA system 150 may be in communication with the energy system 110 via a network 120. The network 120 may be a publicly accessible network of linked networks, possibly operated by various distinct parties, such as the Internet. In other embodiments, the network 120 may include a private network, personal area network, local area network, wide area network, cable network, satellite network, cellular telephone network, etc. or combination thereof, each with access to and/or from the Internet.

The energy data rectification server 140 may be in communication with the SCADA system 150 via another network similar to the network 120 (not shown). The energy data rectification server 140 may include one or more programmed computing devices (which may be geographically distributed), each of which may include a processor and memory. For example, the energy data rectification server 140 may include various components, such as a historical data estimator 142 and a data forecaster 144. The historical data estimator 142 and the data forecaster 144 may each be implemented as executable code modules that are stored in the memory of, and executed by the processor(s) of, the energy data rectification server 140. The historical data estimator 142 and the data forecaster 144 may also be implemented partly or wholly in application-specific hardware. The historical data estimator 142 may be configured to predict or estimate data corresponding to one or more sensors of the energy system 110 for time intervals in which no historical data exists. For example, the energy data rectification server 140 may receive physical data measured by the sensors of the energy system 110 via the SCADA system 150 and store such data in the rectified energy data database 145. Alternatively, not shown, the SCADA system 150 may directly store the physical data in the rectified energy data database 145 and the energy data rectification server 140 may retrieve such data from the rectified energy data database 145. Using the received physical data and the techniques described in greater detail below, the historical data estimator 142 may determine in which time intervals physical data is missing and predict or estimate the missing physical data. The energy data rectification server 140 may transmit the actual and estimated physical data to the user device 160 for display and analysis.

In some embodiments, the historical data estimator 142 is configured to predict or estimate data corresponding to one or more sensors of the energy system 110 for time intervals in which historical data does exist. The historical data estimator 142 may estimate such data using actual physical data and the techniques described below. The historical data estimator 142 may treat the estimated data as a baseline of energy system 110 performance. The historical data estimator 142 may then compare the estimated data with the actual data to measure the performance of the energy system 110 (e.g., to benchmark the performance of the energy system 110). The measured performance may be transmitted to the SCADA system 150 or a separate control system 130 such that the SCADA system 150 or the separate control system 130 can automatically take appropriate action (e.g., adjust the operation or parameters of a component or structure in the energy system 110, generate a report describing past and/or current operation for viewing by an operator, etc.). The historical data estimator 142 may also compare the estimated data with the actual data for fault detection. For example, if the difference between an actual data point and an estimated data point exceeds a threshold value by some confidence, this may indicate that a fault occurred. An indication that a fault is detected may be transmitted to the SCADA system 150 or the separate control system 130 so that appropriate action can be taken. Alternatively, the energy data rectification server 140 may transmit the estimated data to the SCADA system 150 or the separate control system 130 and the SCADA system 150 or the separate control system 130 may perform the performance benchmarking and/or fault detection.

The energy data rectification server 140 may also be configured to predict or estimate data corresponding to one or more sensors of the energy system 110 for time intervals in the future. The data forecaster 144 may forecast such data using actual physical data and the techniques described below. The data forecaster 144 may use the forecasted data to, for example, determine and generate future energy system 110 control sequences that may be used to maintain operational efficiency. For example, if the energy system 110 corresponds to a building and the forecasted data indicates that the next day may be a hot day, then the data forecaster 144 may determine that the heater boiler should be shut off and may generate the appropriate control sequences. The generated control sequences may be transmitted to the SCADA system 150 or the separate control system 130 such that the control sequences can be implemented.

As described above, the user device 160 may receive actual and estimated physical data from the energy data rectification server 140. The user device 160 may display such information in an interactive user interface. Via the user interface, a user may analyze the data to perform a variety of tasks. For example, the energy data rectification server 140 may estimate physical data such that the user interface displays a complete set of physical data for a period of one year. The user interface may allow the user to organize the physical data for client billing, resource tracking (e.g., tracking how many tons of CO₂ are consumed), self-reporting, generating control sequences that may be used to maintain operational efficiency (e.g., control sequences that can be transmitted to the SCADA system 150 or the separate control system 130 for controlling the operation of one or more structures or components in the energy system 110), and/or the like.

While a single user device 160 is illustrated in FIG. 1, this is not meant to be limiting. The energy data rectification system 110 may include any number of user devices 160. The user devices 160 can include a wide variety of computing devices, including personal computing devices, terminal computing devices, laptop computing devices, tablet computing devices, electronic reader devices, mobile devices (e.g., mobile phones, media players, handheld gaming devices, etc.), wearable devices with network access and program execution capabilities (e.g., “smart watches” or “smart eyewear”), wireless devices, set-top boxes, gaming consoles, entertainment systems, televisions with network access and program execution capabilities (e.g., “smart TVs”), and various other electronic devices and appliances. Individual user devices 160 may execute a browser application or other networked-application to communicate with the energy data rectification server 140.

The rectified energy data database 145 may store actual, estimated, and/or forecasted physical data. The rectified energy data database 145 may be located external to the energy data rectification server 140. For example, the rectified energy data database 145 may be stored and managed by a separate system or server and may be in communication with the energy data rectification server 140 via a direct connection or an indirect connection (e.g., via a network, such as the network 120). In other embodiments, not shown, the rectified energy data database 145 is located within the energy data rectification server 140.

While the energy data rectification system of FIG. 1 and the present disclosure is described with respect to energy data, this is merely for illustrative purposes and is not meant to be limiting. The techniques described herein as performed by the energy data rectification server 140 may be applicable to many other applications. For example, the energy data rectification server 140 may use the techniques described herein for transport planning The energy data rectification server 140 may forecast data using historical data to estimate the number of vehicles or people that may use a transportation facility in the future. As another example, the energy data rectification server 140 may use the techniques described herein for telecommunications forecasting. The energy data rectification server 140 may forecast data to allow network planners or a network system to determine how much equipment to purchase to meet demand, to predict network load and adjust parameters accordingly, and/or the like. As another example, the energy data rectification server 140 may use the techniques described herein for data conditioning in remote sensing. Satellites may be used to measure environmental dynamics of the Earth's surface (e.g., temperature, humidity, etc.). However, cloud cover may prevent measurements from certain locations, causing a gap in data. Thus, the energy data rectification server 140 can use the techniques described herein to estimate such missing data. As another example, the energy data rectification server 140 may use the techniques described herein for monitoring a parameter of a condition in a process (e.g., vibration, temperature, etc.) to identify a (significant) change in the parameter that may indicate a fault is developing. As another example, the energy data rectification server 140 may use the techniques described herein for sales forecasting.

### Techniques Implemented by the Energy Data Rectification Server 140

### A) Estimating Physical Data for Periods of Data Dropout

When managing and monitoring networked systems like the energy system 110, data dropouts (e.g., the inability by a sensor or component in the energy system 110 to transmit measurement packets) can be a common issue. Some examples of data dropout can include power outage, loss of sensor calibration, and/or network congestion. When a sensor, such as a building meter, experiences data dropout, sub-hourly usage information may be unavailable for durations of several hours to several months until the issue is resolved. Because of information loss, the evaluation of energy system 110 performance and the cross-comparison of performance between different energy systems 110 can become difficult. To manage this issue, a practitioner often resorts to estimating the missing physical data based on an annualization of measured physical data. However, the energy data rectification server 140 can use predictive models, based on the evaluation of regression models, to estimate physical data during periods of data dropout.

To perform the estimation, the energy data rectification server 140 (e.g., the historical data estimator 142 and/or the data forecaster 144) may first model the behavior of the physical data by generating a regression model. Generally, regression models work by creating a mapping of the input/output relationship between two datasets. Thus, the energy data rectification server 140 may model the behavior of the physical data by generating a regression model that maps a set of inputs to a set of outputs. To model the physical data, the energy data rectification server 140 may use measured or actual physical data as the output dataset and a group of measurements to which the output dataset correlates as the input dataset. Because the physical data (especially if the physical data is derived from a building) may be strongly influenced by the environment, the input dataset may include measurements corresponding to weather variables, such as temperature, solar radiation, and/or relative humidity. However, it is not required that measurements corresponding to weather variables be part of an input dataset. Measurements from other variables may be part of the input dataset, such as measurements corresponding to time variables like hour of the day or day of the week. The measurements used in the input dataset may correspond to the time interval for which actual physical data is present. Thus, the input dataset and the output dataset used by the energy data rectification server 140 to generate the regression model may include data that correspond to the same time interval.

Once the input and output datasets have been selected, the energy data rectification server 140 may select one or more regression model parameters (e.g., coefficients) for a regression model. The regression model parameters may be selected in a manner that, for example, results in a line that closely fits through a plot of the data in the input and output datasets (e.g., using a least squares approach, a maximum-likelihood approach, etc.), where an input data value and an output data value may be plotted together if both values are associated with the same time or time interval. The energy data rectification server 140 may use the one or more regression parameters to generate a single regression model.

In some embodiments, the energy data rectification server 140 selects multiple sets of regression model parameters, where each set corresponds to a separate regression model. For example, different sets of parameters may each result in a line that closely fits through a plot of the data in the input and output datasets. In such a situation, the energy data rectification server 140 may use each set of regression parameters to generate a separate regression model. Thus, the energy data rectification server 140 may generate multiple regression models.

Once the regression model(s) are created, the energy data rectification server 140 can verify each regression model's quality by measuring how well an input dataset estimates the output dataset. If the energy data rectification server 140 generates a single regression model, the energy data rectification server 140 may select the regression model to estimate physical data for time intervals in which data is missing if the verified quality or accuracy of the regression model exceeds (or does not exceed) a threshold. If the energy data rectification server 140 generates multiple regression models, the energy data rectification server 140 may select one of the regression models to estimate the physical data for time intervals in which data is missing based on the verified quality or accuracy of each regression model.

For example, accuracy of the generated regression model(s) can be determined by comparing estimated physical data to actual physical data over a similar time period. The actual physical data may be received from the SCADA system 150 as described above (and may be the same data used in the output dataset when initially generating the regression model that is being verified). The actual physical data may correspond to a first time interval. The estimated physical data may be the outputs of the regression model that is being verified, where the inputs to the regression model may be the same data used in the input dataset when initially generating the regression model and where the inputs correspond to the same first time interval (and thus the estimated physical data may also correspond to the same first time interval).

To gauge the ability of a model to capture temporal dynamic behavior, the energy data rectification server 140 can use probability distribution functions (PDFs) relating to the properties of actual and/or estimated physical data. The comparison of the PDFs of two signals (e.g., actual physical data and physical data estimated or forecasted by a model) may be defined by:

$$W 1 = 2 {\int }_{0}^{0.5} \vert CDF ( M ) - ( CDF ( S ) \vert d w \qquad ( 1 )$$

where the cumulative distribution function (CDF) in the equation can be defined as:

$$CDF ( M ) = \frac{{\int }_{0}^{f} PSD ( M ) d w}{{\int }_{0}^{0.5} PSD ( M ) d w} \qquad ( 2 )$$

where PSD is the power spectral density. In Equations (1) and (2), M can be actual physical data measured over a designated time interval (e.g., measured time-series building meter data during the month of June) and S can be physical data estimated by the regression model that is being verified over the same designated time interval (e.g., time-series building meter data predicted or forecasted by the regression model during the month of June using measurements corresponding to input variables that are associated with the month of June).

The distributions compared may be the normalized power spectral density of actual and estimated physical data (e.g., time-series building meter data). Because building energy consumption may display cyclic behavior over multiple time-scales, with strong daily, weekly, and/or seasonal oscillations, as described in greater detail in Georgescu, Michael, Bryan Eisenhower, and Igor Mezic. 2012. “Creating Zoning Approximations to Building Energy Models using the Koopman Operator.” SimBuild 2012. Proceedings. Fifth National Conference of International Building Performance Simulation Association—USA. 40-47. http://www.ibpsa.us/simbuild2012/Papers/SB12_TS01b_{—}3_Georgescu-pdf Accessed: Jul. 15, 2013, which is hereby incorporated herein by reference in its entirety, a metric like the Wasserstein distance may help determine whether the spectral content of actual physical data is correctly captured in the predicted output of a regression model. The Wasserstein distance is used herein for the purposes of simplicity and is not meant to be limiting. For example, other metrics, such as H2, H infinity, root mean square error, and/or the like, may help determine whether the spectral content of actual physical data is correctly captured in the predicted output of the regression model. In validation tests, the energy data rectification server 140 may calculate model accuracy by determining and using the Wasserstein distance (or any of the other metrics described above). The value of this metric on PDFs is that the Wasserstein distance may measure the ability of a model to recreate the original data initially used by the energy data rectification server 140 to generate the regression model.

In an embodiment, if the energy data rectification server 140 generates a single regression model, the energy data rectification server 140 selects the regression model to estimate physical data for time intervals in which data is missing if the determined Wasserstein distance is less than a threshold value (e.g., 0.005). If the energy data rectification server 140 generates multiple regression models, the energy data rectification server 140 may select the regression model associated with the lowest determined Wasserstein distance as the regression model to use to estimate the physical data for time intervals in which data is missing.

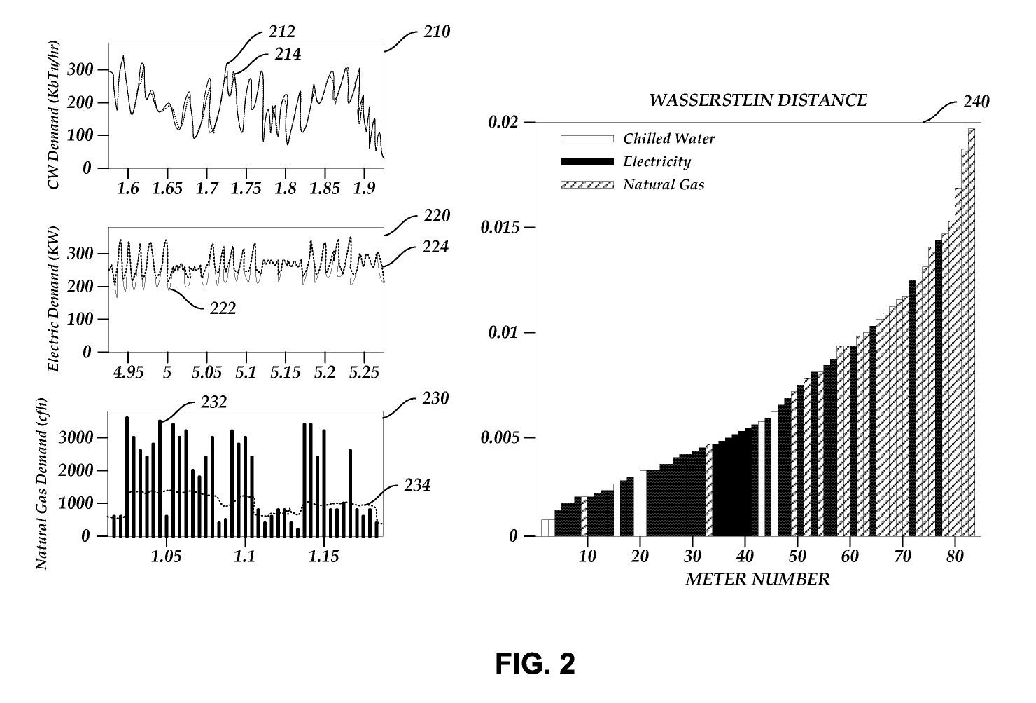

FIG. 2 illustrates results of a validation test. In an example as illustrated in FIG. 2, 86 models were generated by the energy data rectification server 140 using building meter data. Comparing the PDFs of modeled physical data to actual physical data for various meters as depicted in graphs 210, 220, and 230 (where lines 212, 222, and 232 represent actual physical data and lines 214, 224, and 234 represent modeled physical data), the SVR approach of calculating regression models may accurately capture the behavior of many meters. For the graphs 210, 220, and 230 illustrated in FIG. 2, environmental variables may be included in the input dataset when the energy data rectification server 140 generated the regression model. For inaccurate models, environmental variables may be a poor choice for including in the input dataset. As described above, modeled physical data and actual physical data can be compared by analyzing the Wasserstein distance between their respective PDFs. Based on the analysis, the connection between the PDF distances and model performance can be summarized as follows:
Wasserstein Distance<0.005: most spectral features are well captured. The model accurately reflects data.
0.005<Wasserstein Distance<0.01: most spectral features are captured, but amplitude or phase of oscillations may not match.
0.01<Wasserstein Distance: major spectral features are missing. The model does not reflect data. Mismatch often due to non-stationary attributes of sensor data not captured within model inputs (e.g., automatic equipment shutoff at specific times).

With an acceptable regression model, the energy data rectification server 140 can select measurements from variables used in the initial input dataset (e.g., the input dataset used when initially generating the regression model) that correspond to the time interval for which actual physical data is not present as inputs to the regression model. The regression model may then produce, as outputs, estimated physical data for the time intervals in which no historical data is present (e.g., the periods of data dropout). Using these techniques, the energy data rectification server 140 can generate models using a limited amount of physical data and be able to capture expected characteristics of the physical data during periods of data dropout.

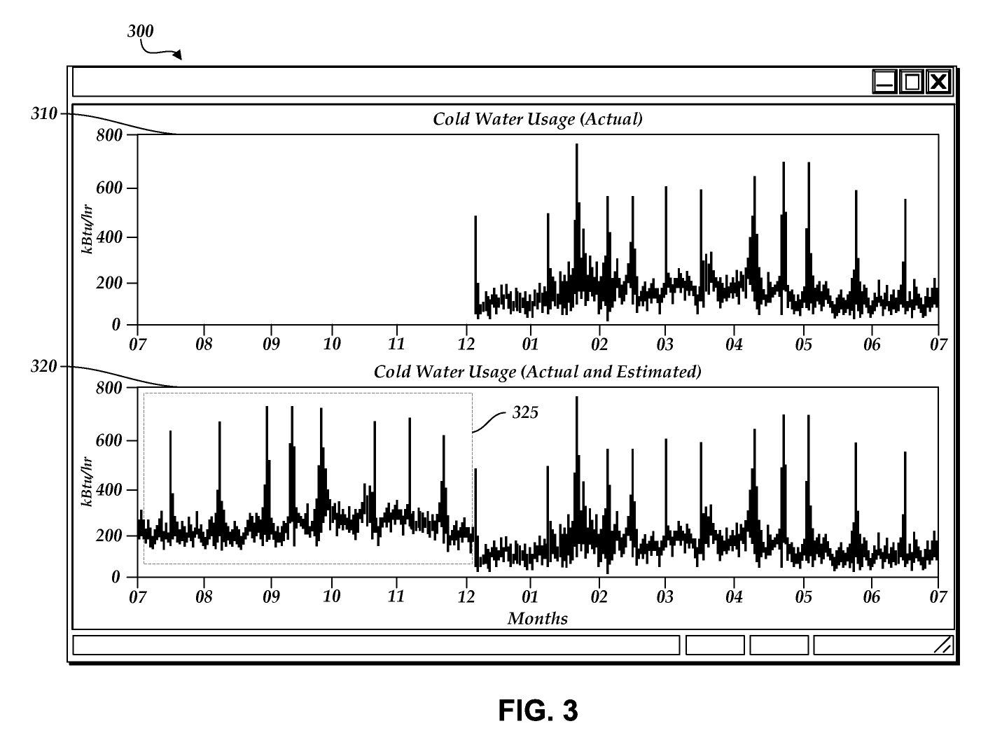

As an example, FIG. 3 illustrates a user interface 300 depicting the yearlong combined actual and estimated consumption of a building meter that exhibited a five month data dropout. The user interface 300 may be displayed by the user device 160. The building meter may measure cold water usage. Specifically, the energy data rectification server 140 may have generated a regression model of the building meter using 7 months of available data (e.g., data depicted in graph 310). The energy data rectification server 140 may then have used the regression model to estimate cold water usage over the 5 month span during which no building meter data exists (e.g., the data depicting in box 325 in graph 320). During the period of data dropout, the regression model may correctly estimate a higher average cold water usage during August and September, which may be the hottest months of the local climate. The energy data rectification server 140 may perform the prediction despite having limited data from which to perform an extrapolation. The now complete building meter output, using a combination of actual and predicted measurements, may help facilitate additional building analysis or adjustments in building operation in a manner as described above.

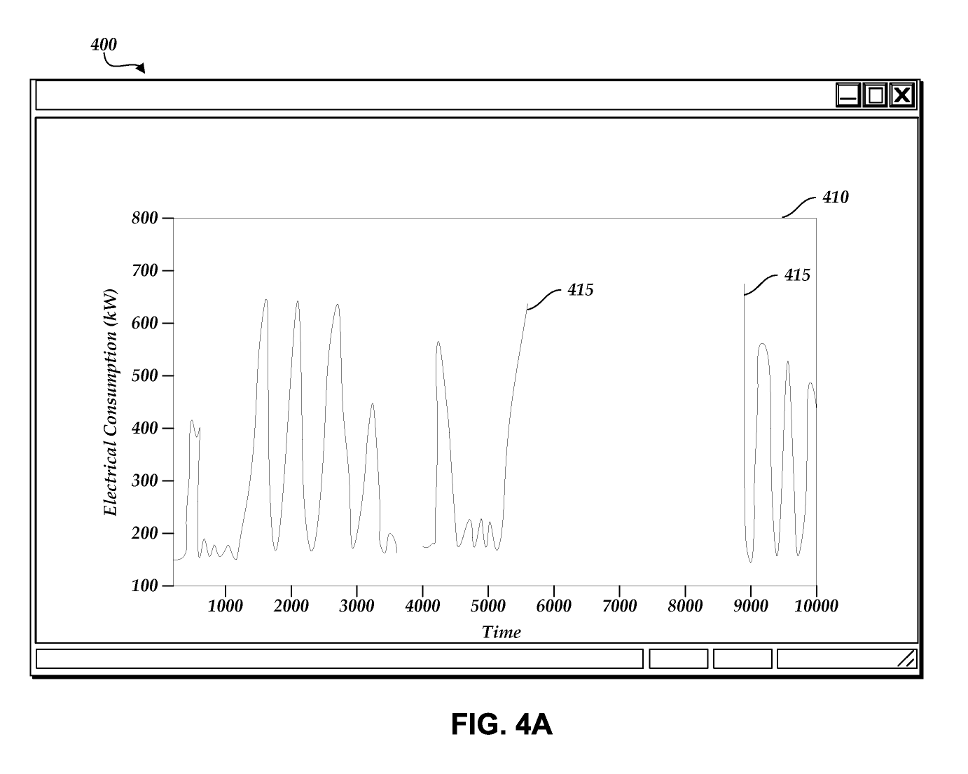

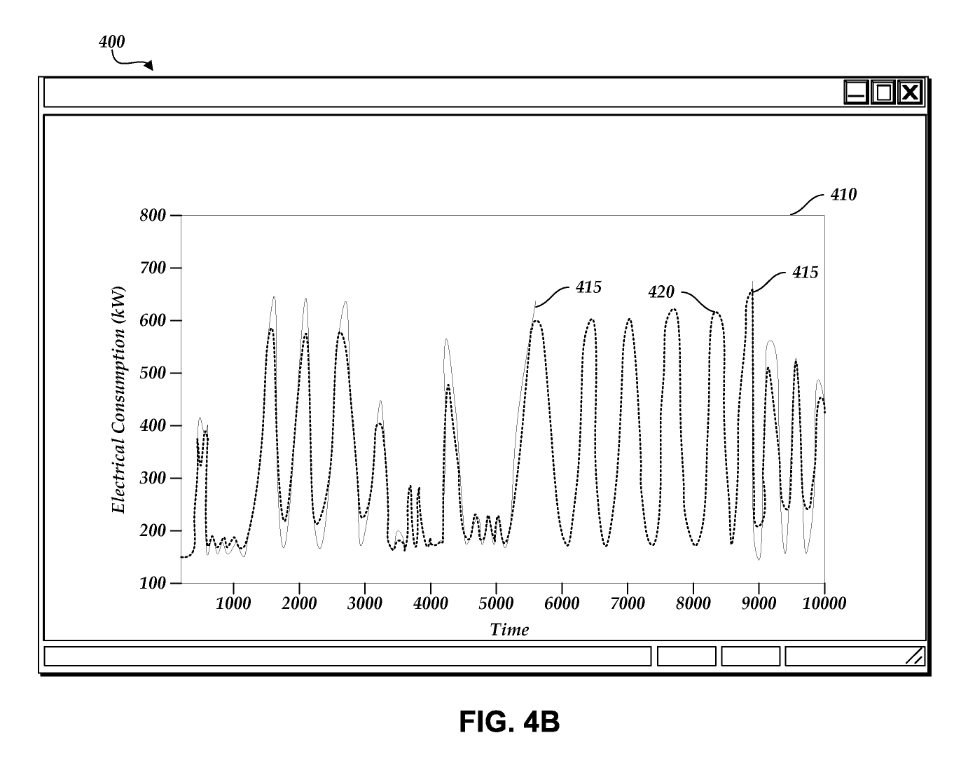

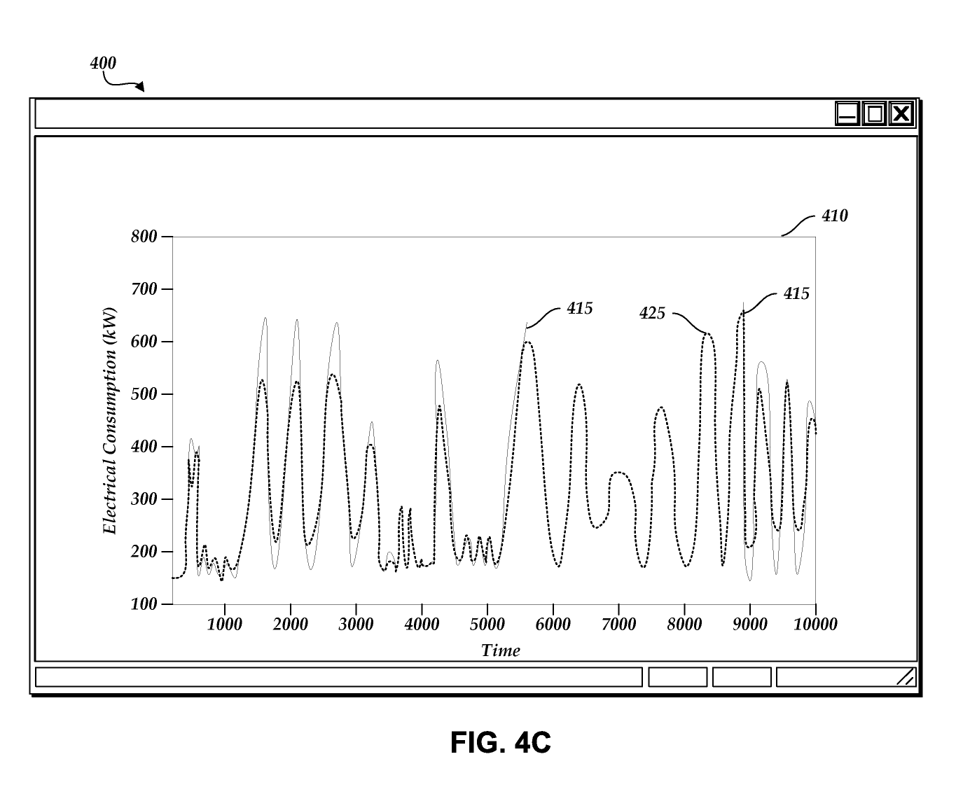

In another example, FIG. 4A illustrates a user interface 400 depicting the measurements collected by a building meter in a 350,000 square foot office building over a month period in which two weeks of data is missing due to a sensor malfunction. The user interface 400 may be displayed by the user device 160. The building meter may measure electrical consumption. Using the measurements depicted in graph 410 as line 415 as an output dataset, the energy data rectification server 140 may use measurements that correlate with the measurements depicted in the graph 410 as an input dataset (e.g., hour of the day and day of the week, as described below) to generate a regression model. The energy data rectification server 140 may then use the generated regression model to estimate the missing building meter data, as illustrated in FIG. 4B as line 420. The missing building meter data may be estimated based on two inputs: the hour of the day and the day of the week. These two inputs may be generated in a pre-processing step. As illustrated in FIG. 4B, over the course of one year of data, the regression model may match the overall actual electrical consumption within 5 percent.

In further embodiments, using the measurements represented by line 415 as an output dataset, the energy data rectification server 140 may use measurements that correlate with the measurements depicted in the graph 410 as an input dataset (e.g., hour of the day, day of the week, and a weather variable, as described below) to generate a regression model. The energy data rectification server 140 may then use the generated regression model to estimate the missing building meter data, as illustrated in FIG. 4C as line 425. Unlike the estimation depicted in FIG. 4B, the missing building meter data as illustrated in FIG. 4C may be based on the hour of the day, the day of the week, and outdoor air temperature. Adding outdoor air temperature as an additional input may allow the generated regression model to better track daily peaks and may remove periodicities that were created in the previous prediction illustrated in FIG. 4B. Furthermore, the accuracy over a one year period may be maintained with the regression model matching the overall actual electrical consumption within 6 percent.

As described herein, the energy data rectification server 140, using the techniques described above, may accurately predict at any relevant time scale (e.g., hourly, minutely, sub-minutely, etc.) missing physical data. The time scale by which the energy data rectification server 140 estimates physical data may only be limited by the measurement equipment (e.g., sensors) included in the energy system 110.

Additionally, the energy data rectification server 140 can use a model, such as a building energy model (or any other input data, or combination of input data, reflecting an actual condition) as an input in place of or to augment actual environmental data in the input dataset to achieve a forecast of an expected future input. The prediction produced by the regression model may then represent a forecast of future events. As an example, the resulting forecast can be used by the energy data rectification server 140 for demand response by a priori determining the time intervals where specific events are likely to occur (e.g., future energy demands that cannot be satisfied).

### Example Process for Rectifying Physical Data

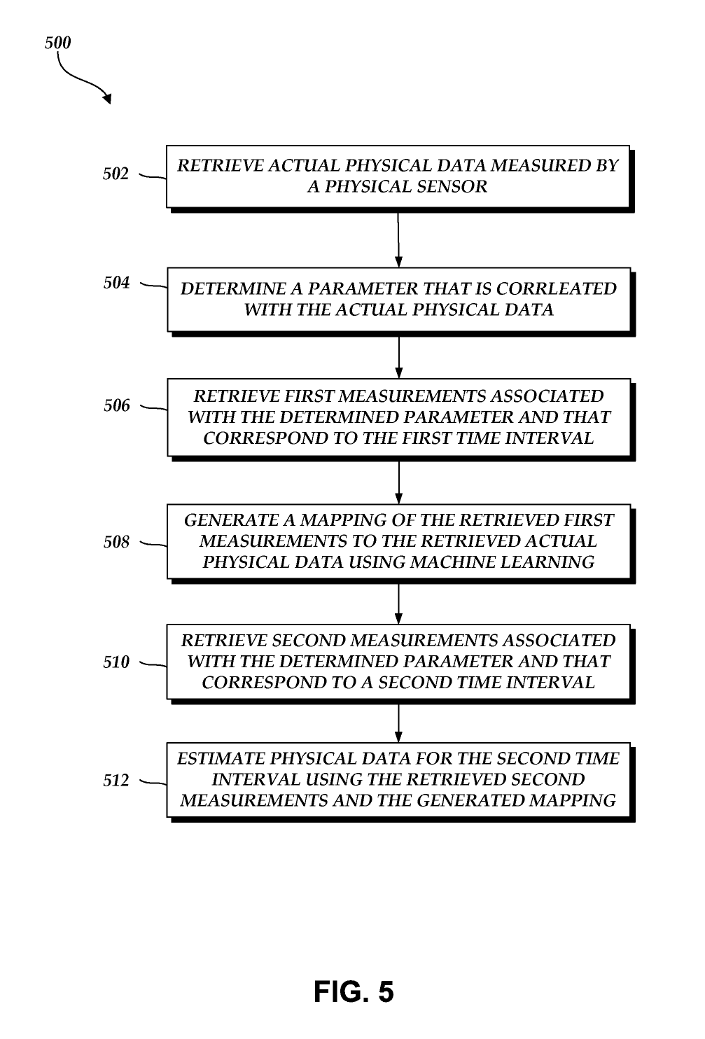

FIG. 5 illustrates a process 500 that may be used by the energy data rectification server 140 to rectify missing physical data. As an example, the historical data estimator 142 or the data forecaster 144 of FIG. 1 can be configured to implement the process 500. The process 500 begins at block 502.

At block 502, actual physical data measured by a physical sensor is retrieved. The actual physical data may be retrieved from a SCADA system, such as the SCADA system 150, or from a database, such as the rectified energy data database 145. The actual physical data may correspond to a first time interval. The physical sensor may be a component included in an energy system, such as the energy system 110.

At block 504, a parameter that is correlated with the actual physical data is determined. For example, the parameter may be a weather variable, such as temperature, solar radiation, or relative humidity. The parameter may be correlated with the actual physical data because the parameter affects the values of the actual physical data.

At block 506, first measurements associated with the determined parameter and that correspond to the first time interval are retrieved. The first measurements may be retrieved from any internal or external database (e.g., via a network like the network 120).

At block 508, a mapping of the retrieved first measurements to the retrieved actual physical data is generated using machine learning. For example, a regression model, such as an SVR, may be used to generate the mapping. The process 500 at block 508 may validate the mapping (e.g., validate the regression model) as described herein before proceeding to block 510. For example, the process 500 may use the mapping and the first measurements to generate estimated physical data. The process 500 may then compare the estimated physical data with the retrieved actual physical data to determine a metric, such as the Wasserstein distance, that may indicate whether the spectral content of the retrieved actual physical data is correctly captured in the predicted output of the regression model.

At block 510, second measurements associated with the determined parameter and that correspond to a second time interval are retrieved.

At block 512, physical data for the second time interval is estimated using the retrieved second measurements and the generated mapping. As described herein, the estimated physical data may be used for performance benchmarking, fault detection, and/or to generate control sequences for future energy system 110 operation.

Additional information on the present disclosure may be found in a published manuscript, Michael Georgescu, Emma Eccles, Varsha Manjunath, Emily Swindle and Igor Mezic, “Machine Learning Methods for Site-Level Building Energy Forecasting and Data Rectification,” BSO14 Conference, June 2014, which is hereby incorporated herein by reference in its entirety.

### Additional Embodiments

The energy data rectification server 140 of FIG. 1 may be a single computing device, or it may include multiple distinct computing devices, such as computer servers, logically or physically grouped together to collectively operate as a server system. The components of the energy data rectification server 140 can each be implemented in application-specific hardware (e.g., a server computing device with one or more ASICs) such that no software is necessary, or as a combination of hardware and software. In addition, the modules and components of the energy data rectification server 140 can be combined on one server computing device or separated individually or into groups on several server computing devices. In some embodiments, the energy data rectification server 140 may include additional or fewer components than illustrated in FIGS. 1A-B.

In some embodiments, the features and services provided by the energy data rectification server 140 may be implemented as web services consumable via the communication network 120. In further embodiments, the energy data rectification server 140 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, and/or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on general purpose computer hardware, or combinations of both. To clearly illustrate this interchangeability of hardware and software, various illustrative components, blocks, modules, and steps have been described above generally in terms of their functionality. Whether such functionality is implemented as specialized hardware versus software running on general-purpose hardware depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system for physical data rectification, the system comprising:
a computer data repository configured to store a data set, the data set comprising actual physical data measured by a physical sensor; and
a computing system comprising one or more computing devices, the computing system in communication with the computer data repository and programmed to implement:
a historical data estimator configured to:
retrieve the actual physical data from the computer data repository, wherein the actual physical data corresponds to a first time interval;
determine a parameter that is correlated with the actual physical data;
retrieve first measurements associated with the determined parameter and that correspond to the first time interval;
generate a mapping of the retrieved first measurements to the retrieved actual physical data using machine learning;
retrieve second measurements associated with the determined parameter and that correspond to a second time interval that is different than the first time interval; and
estimate physical data for the second time interval using the retrieved second measurements and the generated mapping.

2. The system of claim 1, wherein the historical data estimator is further configured to:
estimate second physical data for the first time interval using the retrieved first measurements and the generated mapping;
compare the estimated second physical data and the retrieved actual physical data; and
determine a performance benchmark associated with the physical sensor based on the comparison.

3. The system of claim 1, wherein the historical data estimator is further configured to:
estimate second physical data for the first time interval using the retrieved first measurements and the generated mapping;
compare the estimated second physical data and the retrieved actual physical data;
determine a difference between the estimated second physical data and the retrieved actual physical data based on the comparison; and
determine that a fault has occurred in response to a determination that the difference is greater than a threshold value.

4. The system of claim 3, wherein the historical data estimator is further configured to transmit an indication to a user device that the fault has occurred.

5. The system of claim 1, wherein the physical sensor is located in one of a building, an industrial process, a vehicle, a power grid, a renewable energy source, or a conventional energy source.

6. The system of claim 1, wherein the computer system is further programmed to implement a data forecaster configured to:
generate a control sequence based on the estimated physical data; and
transmit the control sequence to a control system such that the control system can adjust operation of the physical sensor.

7. The system of claim 6, wherein the control system is a supervisory control and data acquisition system.

8. The system of claim 1, wherein the parameter is at least one of hour of a day, day of a week, temperature, solar radiation, or relative humidity.

9. The system of claim 1, wherein the actual physical data comprises at least one of voltage, current, temperature, humidity, air flow, electric power usage, water usage, gas usage, occupancy, light, smoke, or network packets.

10. The system of claim 1, wherein the physical sensor comprises at least one of a thermostat, a humidistat, or a utility meter.

11. The system of claim 1, wherein the historical data estimator is further configured to generate the mapping using a regression model.

12. The system of claim 11, wherein the regression model comprises a support vector regression.

13. A method for rectifying physical data, the method comprising:
as implemented by a computer system comprising one or more computing devices, the computer system configured with specific executable instructions, retrieving actual physical data measured by a physical sensor from a control system, wherein the actual physical data corresponds to a first time interval;
determining a parameter that is correlated with the actual physical data;
retrieving first measurements associated with the determined parameter and that correspond to the first time interval;
generating a mapping of the retrieved first measurements to the retrieved actual physical data using machine learning;
retrieving second measurements associated with the determined parameter and that correspond to a second time interval that is different than the first time interval; and
estimating physical data for the second time interval using the retrieved second measurements and the generated mapping.

14. The method of claim 13, further comprising:
estimating second physical data for the first time interval using the retrieved first measurements and the generated mapping;
comparing the estimated second physical data and the retrieved actual physical data; and
determining a performance benchmark associated with the physical sensor based on the comparison.

15. The method of claim 13, further comprising:
estimating second physical data for the first time interval using the retrieved first measurements and the generated mapping;
comparing the estimated second physical data and the retrieved actual physical data;
determining a difference between the estimated second physical data and the retrieved actual physical data based on the comparison; and
determining that a fault has occurred in response to a determination that the difference is greater than a threshold value.

16. The method of claim 15, further comprising transmitting an indication to a user device that the fault has occurred.

17. The method of claim 13, wherein the physical sensor is located in one of a building, an industrial process, a vehicle, a power grid, a renewable energy source, or a conventional energy source.

18. The method of claim 13, further comprising:
generating a control sequence based on the estimated physical data; and
transmitting the control sequence to a control system such that the control system can adjust operation of the physical sensor.

19. The method of claim 13, wherein generating a mapping comprises generating the mapping of the retrieved first measurements to the retrieved actual physical data using a regression model.

20. A non-transitory computer-readable medium having stored thereon a historical data estimator for using machine-learning techniques to rectify physical data, the historical data estimator comprising executable code that, when executed on a computing device, implements a process comprising:
retrieving actual physical data measured by a physical sensor from a control system, wherein the actual physical data corresponds to a first time interval;
determining a parameter that is correlated with the actual physical data;
retrieving first measurements associated with the determined parameter and that correspond to the first time interval;
generating a mapping of the retrieved first measurements to the retrieved actual physical data using machine learning;
retrieving second measurements associated with the determined parameter and that correspond to a second time interval that is different than the first time interval; and
estimating physical data for the second time interval using the retrieved second measurements and the generated mapping.
